(19) United States
(12) Patent Application Publication
(10) Pub. No.: US 2025/0341415 A1
(43) Pub. Date: Nov. 6, 2025

(54) SYSTEM AND METHOD FOR DETERMINING FLOW PARAMETER OF FLOW OF FLUID FROM OR INTO RECEPTACLE

(71) Applicant: MANN+HUMMEL Ventures Pte. Ltd., Singapore (SG)

(72) Inventors: Matthew NUNN, Singapore (SG); Xin Wei YEAP, Singapore (SG); Kevin STOCK, Fort Wayne, IN (US); Alexander UBL, Raleigh, NC (US); Wilson TEACHEY, Raleigh, NC (US)

(21) Appl. No.: 18/655,179

(22) Filed: May 3, 2024

(51) Int. Cl. G01F 23/80

(52) U.S. Cl. CPC G01F 23/804

(57) ABSTRACT

Disclosed is a system and methods for determining, a flow parameter of a channel of a receptacle, the flow parameter indicative of a flow of a fluid from or into the receptacle via the channel, the system comprising a flow control device configured to convey the fluid from or into the receptacle; a processor configured to obtain, a historical data comprising, a historical operating parameter indicative of a historical operating status of the flow control device, and a historical filling parameter indicative of a historical filling state of the receptacle; determine, a flow estimate parameter of the channel indicative of an estimated flow of the fluid from or into the receptacle, when the flow control device is in an OFF state, based on the historical data; and determine, the flow parameter of the channel, based on the flow estimate parameter of the channel, and the historical filling parameter.

### TECHNICAL FIELD

Various aspects of this disclosure relate to a system for determining a flow parameter indicative of a flow of a fluid from or into a receptacle, via a channel of the receptacle, and a method of operating said system for determining the flow parameter.

### BACKGROUND ART

The following discussion of the background art is intended to facilitate an understanding of the present disclosure only. It should be appreciated that the discussion is not an acknowledgement or admission that any of the material referred to was published, known or is part of the common general knowledge of the person skilled in the art in any jurisdiction as of the priority date of the disclosures.

Conventional systems for estimating water flow from or into a water tank, typically employ the use of specialized instruments, such as flow meters, for measuring and monitoring water flow.

Such flow meters require regular calibration and maintenance, and are often expensive. Further, spare parts for such flow meters may not be readily obtainable.

In addition, flow meters have a relatively high error rate when measuring water flow, often due to the occurrence of air bubbles, and a user is unable to accurately measure and monitor the water flow from or into the tank.

Accordingly, there exists a need for an improved system that seeks to address at least one of the aforementioned problems.

### SUMMARY

The disclosure was conceptualized to provide an improved system for determining flow parameters of a channel to transfer fluid from or into the receptacle, and a flow control device to convey fluid into or from the receptacle, the channel and the flow control device each being arranged in fluid communication with a receptacle. In one non-limiting example, the flow control device refers to a pump, such as a water pump. The improved system determines, a first flow parameter being indicative of a flow of a fluid from or into the receptacle via the channel; and a second flow parameter being indicative of a flow of the fluid conveyed into or out of the receptacle via the flow control device. To this end, the improved system considers at least, a change in a historical filling parameter indicative of a historical filling state of an internal volume of the receptacle, for determining the first flow parameter of the channel and/or the second flow parameter of the flow control device. The improved system reduces and/or removes the need for the use of conventional flow meters for measuring and monitoring the flow of the fluid from or into the receptacle via channels, and/or measuring and monitoring the conveying of a fluid from or into the receptacle via flow control devices, thereby reducing installation, operating and/or maintenance costs related to such conventional flow meters. In addition, the improved system is able to determine the flow parameter with improved accuracy, when compared with conventional flow meters.

According to a first aspect of the disclosure, there is provided a system for determining a first flow parameter of a channel, the channel arranged in fluid communication with a receptacle, the first flow parameter indicative of a flow of a fluid from or into the receptacle via the channel, the system comprising a flow control device in fluid communication with the receptacle, the flow control device configured to convey the fluid from the receptacle, or configured to convey the fluid into the receptacle; a processor configured to: obtain, a historical data comprising at least one of, a historical operating parameter indicative of a historical operating status of the flow control device; a historical filling parameter indicative of a historical filling state of an internal volume of the receptacle; determine, a first flow estimate parameter of the channel, the first flow estimate parameter indicative of an estimated flow of the fluid from or into the receptacle via the channel, when the flow control device is in an OFF state, based on the historical data; and determine, the first flow parameter of the channel, based on the first flow estimate parameter of the channel, and the historical filling parameter.

In various embodiments, determining, the first flow estimate parameter of the channel, based on the historical data, comprises determining, a change in the historical filling parameter; and determining, the first flow estimate parameter of the channel, based on the change in the historical filling parameter and the historical operating parameter.

In various embodiments, the change in the historical filling parameter indicative of the historical filling state of the internal volume of the receptacle, when the flow control device is in the OFF state comprises, a difference between a first historical filling state comprising a first level of the fluid in the receptacle at a first sampled time; and a second historical filling state comprising a second level of the fluid in the receptacle at a second sampled time.

In various embodiments, the processor is further configured to obtain, a present data comprising a present power parameter indicative of a present power utilized by the flow control device and determine, a present efficiency of the flow control device, based on the present power parameter.

In various embodiments, the historical data further comprises a historical power parameter indicative of a historical power utilized by the flow control device, wherein the processor is further configured to determine, a historical efficiency of the flow control device, based on the historical power parameter, and determine, a difference between the historical efficiency and the present efficiency, of the flow control device.

In various embodiments, the processor is configured to obtain, the historical operating parameter based on the historical power parameter.

In various embodiments, the present data further comprises at least one of, a present operating parameter indicative of a present operating status of the flow control device; a present filling parameter indicative of a present filling state of the internal volume of the receptacle; wherein the processor is further configured to determine, a second flow parameter of the flow control device, when the flow control device is in an ON state, based on the first flow parameter of the channel, the present operating parameter, and/or the present filling parameter.

In various embodiments, the present filling parameter indicative of the present filling state of the internal volume of the receptacle comprises, a third level of the fluid in the receptacle at a third sampled time.

In various embodiments, the flow control device comprises two or more second flow control devices, wherein each of the two or more second flow control devices are in fluid communication with the receptacle, and configured to convey the fluid from the receptacle, or to convey the fluid into the receptacle, wherein the two or more second flow control devices each have a same operating configuration, and wherein the present data further comprises, the present operating parameter indicative of the present operating status of each of the two or more second flow control devices; wherein the processor is further configured to determine, the second flow parameter for each of the two or more second flow control devices, when a respective one of the two or more second flow control devices are in the ON state, based on the first flow parameter of the channel, the present operating parameter for the respective one of the two or more second flow control devices, and the present filling parameter.

In various embodiments, the internal volume of the receptacle comprises, a section profile along a vertical axis of the receptacle.

In various embodiments, the first flow parameter of the channel comprises, a rate of the flow of the fluid from or into the receptacle, and wherein the first flow estimate parameter of the channel comprises, a rate of the estimated flow of the fluid from or into the receptacle, when the flow control device is in the OFF state.

In various embodiments, wherein when the flow control device is configured to convey the fluid from the receptacle, the first flow parameter of the channel comprises the flow of the fluid into the receptacle.

In various embodiments, wherein when the flow control device is configured to convey the fluid into the receptacle, the first flow parameter of the channel comprises the flow of the fluid from the receptacle.

In various embodiments, the fluid comprises water, or wastewater.

In various embodiments, the flow control device comprises an electrical pump.

According to a second aspect of the disclosure, there is provided a wastewater treatment plant comprising the system of the first aspect of the disclosure.

According to a third aspect of the disclosure, there is provided a control device comprising a processor for determining a first flow parameter of a channel for a system, the channel arranged in fluid communication with a receptacle, the first flow parameter indicative of a flow of a fluid from or into the receptacle; the system comprising a flow control device in fluid communication with the receptacle, the flow control device configured to convey the fluid from the receptacle, or configured to convey the fluid into the receptacle; the processor being in data communication with a memory having instructions stored therein, the instructions, when executed by the processor, causes the processor to: obtain, a historical data comprising at least one of, a historical operating parameter indicative of a historical operating status of the flow control device; a historical filling parameter indicative of a historical filling state of an internal volume of the receptacle; determine, a first flow estimate parameter of the channel, the first flow estimate parameter indicative of an estimated flow of the fluid from or into the receptacle via the channel, when the flow control device is in an OFF state, based on the historical data; and determine, the first flow parameter of the channel, based on the first flow estimate parameter of the channel, and the historical filling parameter.

According to a third aspect of the disclosure there is provided a method for determining a first flow parameter of a channel for a system, the channel arranged in fluid communication with a receptacle, the first flow parameter indicative of a flow of a fluid from or into the receptacle; the system comprising a flow control device in fluid communication with the receptacle, the flow control device configured to convey the fluid from the receptacle, or configured to convey the fluid into the receptacle; the method comprising providing a processor for obtaining, a historical data comprising at least one of, a historical operating parameter indicative of a historical operating status of the flow control device; a historical filling parameter indicative of a historical filling state of an internal volume of the receptacle; determining, a first flow estimate parameter of the channel, the first flow estimate parameter indicative of an estimated flow of the fluid from or into the receptacle via the channel, when the flow control device is in an OFF state, based on the historical data; and determining, the first flow parameter of the channel, based on the first flow estimate parameter of the channel, and the historical filling parameter.

In various embodiments, determining, the first flow estimate parameter of the channel based on the historical data, comprises determining, a change in the historical filling parameter; and determining, the first flow estimate parameter of the channel, based on the change in the historical filling parameter and the historical operating parameter.

In various embodiments, the change in the historical filling parameter indicative of the historical filling state of the internal volume of the receptacle, when the flow control device is in the OFF state comprises, a difference between a first historical filling state comprising a first level of the fluid in the receptacle at a first sampled time; and a second historical filling state comprising a second level of the fluid in the receptacle at a second sampled time.

According to another aspect of the disclosure, there is provided a computer readable medium comprising instructions, which when executed by the processor, causes the processor to perform the method of the third aspect.

### BRIEF DESCRIPTION OF DRAWINGS

The disclosure will be better understood with reference to the detailed description when considered in conjunction with the non-limiting examples and the accompanying drawings, in which:

FIG. 1 shows an exemplary schematic illustration of a system 100 for determining a first flow parameter 164 of a channel 114, and a second flow parameter 168 of a flow control device 116, the channel 114 and the flow control device 116 arranged in fluid communication with a receptacle 110;

FIG. 2 shows an exemplary schematic illustration of a receptacle 110 for containing fluid 102;

FIG. 3 shows an exemplary schematic illustration for determining a change in the historical filling parameter 160, when the flow control device 116 is in the OFF state;

FIG. 4 shows an exemplary schematic illustration for obtaining the historical filling parameter 160 at various sampled times when the flow control device 116 is in the ON state;

FIG. 5 shows an exemplary schematic illustration of obtaining, a present filling parameter 166 indicative of the present filling state of the internal volume 202 of the receptacle 110;

FIG. 6 shows another exemplary schematic illustration of a system 600 for determining a first flow parameter 664 of a channel 614, and a second flow parameter 668 of a flow control device 616, the channel 614 and the flow control device 616 arranged in fluid communication with a receptacle 110;

FIG. 7 shows an exemplary schematic illustration of a control device 700 comprising a processor 720 for determining a first flow parameter of a channel, and a second flow parameter of a flow control device, for a system;

FIG. 8 shows an exemplary flowchart of a method 800 for determining, a first flow parameter of a channel, and a second flow parameter of a flow control device, for a system; and

FIG. 9 shows a series of graphs 900 demonstrating the performance of the exemplary improved system 600 for determining the first flow parameter 664 of the channel 614, and the second flow parameter 668 of the flow control device 616, e.g. first flow control device, and the another flow control device, e.g. second flow control device.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements. As used herein, the term “and/or” includes any and all combinations of one or more of the associated listed items.

While such terms as “first,” “second,” etc., may be used to describe various elements, such elements must not be limited to the above terms. The above terms are used only to distinguish one element from another, and do not define corresponding elements, for example, an order and/or significance of the elements. Without departing a scope of rights of the specification, a first element may be referred to as a second element, and similarly, the second element may be referred to as the first element.

Throughout the description, the term “fluid”, as used herein, may refer to any substance suitable for having a flow, for example, a gas or a liquid. In various embodiments, the fluid may be a liquid. In some embodiments, the fluid may include water as a constituent, such as wastewater.

Throughout the description, the terms “from” and “into”, as used herein, may be terms relative to the fluid contained in the receptacle. The term “from”, may refer to the transfer of fluid from an interior of the receptacle to an exterior of the receptacle, for example, the transfer into another container. Accordingly, the term “into”, may refer to the transfer of fluid from an exterior of the receptacle, for example, from another container, into an interior of the receptacle. The transfer of fluid from or into the receptacle, may be facilitated by a channel and/or a flow control device, each being in fluid communication with the receptacle.

Throughout the description, the term “level”, as used herein, may refer to a level assumed by a surface of a fluid body, e.g. fluid volume in the receptacle. In various embodiments, the level of the fluid may be obtained with respect to the base of the receptacle. The level of the fluid may be expressed in units of distance, e.g. meters. In various embodiments, the level of the fluid may be measured when fluid is being transferred from or into the receptacle.

Throughout the description, the term “flow control device”, as used herein, may refer to any device suitable for facilitating and conveying a flow of the fluid. In various embodiments, the flow control device may be conveying the fluid actively, for example, via the use of a pump. In some embodiments, the flow control device may be conveying the fluid passively, for example, via means for facilitating the flow of the fluid via gravity.

Throughout the description, the term “flow parameter”, as used herein, may refer to a volumetric flow rate of a fluid, and/or a total volumetric flow of a fluid. Accordingly, the term “flow estimate parameter”, may refer to an estimated volumetric flow rate of the fluid, and/or an estimated total volumetric flow of the fluid. In one non-limiting example, the volumetric flow rate, total volumetric flow, estimated volumetric flow rate and/or estimated total volumetric flow of the fluid, may be measured in various units of a ratio of the fluid volume per time unit, e.g. volume in meters cube per hour (m³/hour). In another non-limiting example, a volumetric flow rate, total volumetric flow, estimated volumetric flow rate and estimated total volumetric flow of the fluid may be based on various units of a ratio of the distance, e.g. level of the fluid in the receptacle per time, e.g. m/hour, wherein the surface area (which may be in units of m²) of the receptacle is constant.

Throughout the description, the term “processor”, refers to a circuit, including analog circuits or components, digital circuits or components, hybrid circuits or components. Any other kind of implementation of the respective functions which will be described in more detail below may also be understood as a “circuit” in accordance with an alternative embodiment. A digital circuit may be understood as any kind of a logic implementing entity, which may be special purpose circuitry or a processor executing software stored in a memory, firmware, or any combination thereof. The processor may also include a single stand-alone computer, a single dedicated server, multiple dedicated servers, and/or a virtual server running on a larger network of servers and/or cloud-based services. Accordingly, the phrase “a processor configured to determine”, may refer to the processor that has been pre-programmed or is programmable with a predetermined program, e.g. software comprising instructions, to execute the determination of the various parameters of the disclosure.

Throughout the description, the term “historical data”, as used herein, may refer to past events or data related to the historical operating status of the flow control device, the historical power utilized by the flow control device, and/or the historical filling state of an internal volume of the receptacle. In the context of the disclosure, the processor may obtain the historical data, at a time for determining the first flow parameter of the channel. Accordingly, the term “present data”, as used herein, may refer a current or existing data related to the present operating status of the flow control device, the present power utilized by the flow control device, and/or a present filling state of an internal volume of the receptacle. In the context of the disclosure, the processor may obtain the present data at a time for determining the second flow parameter of the flow control device.

Throughout the description, the term “obtain”, as used herein, may refer to the processor that actively obtains, or passively receives information, e.g. parameters, data or information, from a storage device, e.g. memory and/or sensors of the receptacle. The processor may also obtain various data types from a communication interface, e.g. a user interface. The communication interface may be located on the processor of the system. The processor may also receive or obtain the various data types via a register or an analog-to-digital port. Accordingly, the phrase “a processor configured to obtain” may refer to the processor being operably in data communication with a source device, e.g. a sensor, a memory, a cloud, a server, and/or another processor, to obtain or receive the relevant data. This may, in some cases, further include sending instruction to the source to provide, e.g. send, said relevant data.

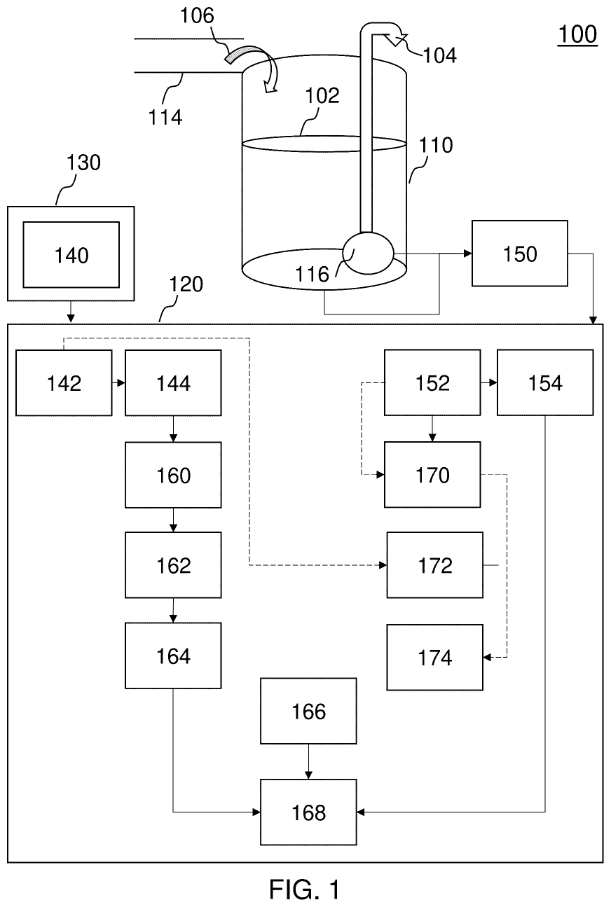

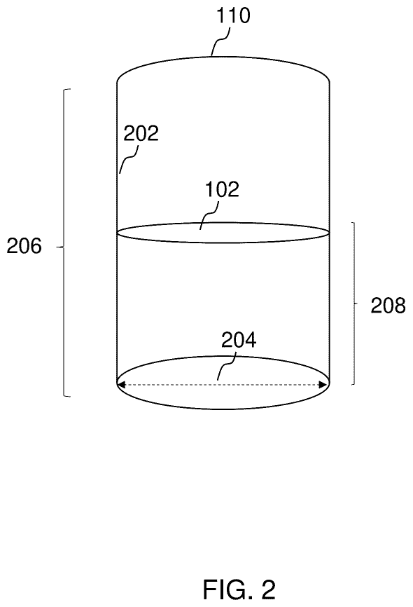

FIG. 1 shows an exemplary schematic illustration of a system 100 for determining a first flow parameter 164 of a channel 114, and a second flow parameter 168 of a flow control device 116, the channel 114 and the flow control device 116 arranged in fluid communication with a receptacle 110, in accordance with various embodiments of an aspect of the disclosure. FIG. 2 shows an exemplary schematic illustration of a receptacle 110 for containing fluid 102.

Referring to FIGS. 1 and 2, system 100 includes a receptacle 110 suitable for containing a fluid 102, in particular a liquid, the liquid may be water or wastewater. The receptacle 110 may be any one of a vessel, tank, or containers suitable for containing fluid 102. The receptacle 110 may have a dimension, e.g. profile such as form or shape, and may be manufactured of any material type suitable for containing the fluid 102. In various embodiments, the receptacle 110 may have an internal volume 202, which may refer to a section profile 204 along a vertical axis 206 of the receptacle 110. In some embodiments, the section profile 204 may refer to the (cross-) section area of the receptacle 110, and the vertical axis 206 of the receptacle 110 may refer to the height of the receptacle 110. In other words, the internal volume 202 may be the vertical capacity profile of the receptacle 110 along its vertical axis 206, and therefore considers the profile, height and (cross-) section area 204 of said receptacle 110. While FIG. 2, shows a receptacle 110 having a cylindrical profile, embodiments of the disclosure are not limited thereto, and the receptacle 110 may have any suitable profile, for example, a cuboidal, a prism profile.

As shown in FIG. 1, system 100 further includes a channel 114 arranged in fluid communication with the receptacle 110, the channel 114 configured to permit a flow of the fluid 102 into 106 the receptacle 110. In various embodiments, the channel 114 may be arranged to permit a passive flow of the fluid 102 into 106 the receptacle 110, for example, the fluid 102 may flow into 106 the receptacle 110 via gravity. It is contemplated that the channel 114 may be arranged to permit an active flow of the fluid 102 into 106 the receptacle 110, for example, via a pump.

As shown in FIG. 1, system 100 further includes a flow control device 116 arranged in fluid communication with the receptacle 110, and configured to convey the fluid 102 from 104 the receptacle 110. In various embodiments, the flow control device 116 may be electrically driven and may be an electrical pump. The flow control device 116 may actively convey the fluid 102 from 104 the receptacle 110. It is contemplated that the flow control device 116 may be configured permit a passive flow of the fluid 102 from 104 the receptacle 110, for example, via gravity.

System 100 further includes a processor 120 in data communication with a storage device 130, e.g. memory, for determining a first flow parameter 164 of the channel 114. The storage device 130 may store a historical data 140 relating to the flow control device 116, and the filling state of the receptacle 110. In various embodiments, the historical data 140 may refer to data stored over a period ranging from 6 hours to 2 weeks. In some embodiments, the historical data 140 may refer to a 24 hour period.

The historical data 140 may comprise a historical operating parameter 144 indicative of a historical operating status of the flow control device 116. For example, the historical operating parameter 144 may refer to a historical status of the flow control device 116 when it is in the ON state, i.e. in operation, and conveying the fluid 102 from 104 the receptacle 110; or in the OFF state, i.e. not in operation, and may not convey the fluid 102 from 104 the receptacle 110. In the context of the disclosure, the OFF state may refer to a fully OFF state, where the flow control device 116 may not be ready to operate, e.g. when power supplied for operating the flow control device 116 may be switched off. In various embodiments, the OFF state may also include a ready state, where the flow control device 116 is not in operation but ready to operate.

The historical data 140 may further comprise a historical power parameter 142 indicative of a historical power utilized by the flow control device 116. The historical power parameter 142 may refer to a historical power, voltage and/or current utilized by the flow control device 116. In various embodiments, the processor 120 may obtain, the historical operating parameter 144 based on the historical power parameter 142. For example, the processor 120 may determine, the historical operating parameter 144 of the flow control device 116 being in the ON state, when the historical power parameter 142 has a value greater than 0, indicating that the flow control device 116 is in operation. In another example, the processor 120 may determine, the historical operating parameter 144 of the flow control device 116 being in the OFF state, when the historical power parameter 142 has a value equal to or less than 0, indicating that the flow control device 116 is not in operation.

The historical data 140 may further comprise a historical filling parameter 160 indicative of a historical filling state of the internal volume 202 of the receptacle 110. The historical filling state of the internal volume 202 may refer to a level 208 of the fluid 102 in the receptacle 110 at a historical sampled time. The level 208 of the fluid 102 may be measured using one or more sensors, e.g. fluid level sensors, configured to measure the level 208 of the fluid 102. In various embodiments, the fluid level sensor may be a pressure sensor placed at a certain depth in the receptacle 110, and configured to output the level 208 of the fluid 102 based on the measured pressure of the fluid 102 contained in the receptacle 110.

In system 100, the processor 120 obtains, the historical data 140 from the storage device 130, the historical data 140 comprising at least one of the historical operating parameter 144, and/or the historical filling parameter 160, and determines, a first flow estimate parameter 162 of the channel 114 indicative of an estimated flow of the fluid 102 into 106 the receptacle 110 via the channel 114, when the flow control device 116 is in the OFF state, based on the historical data 140. In various embodiments, the first flow estimate parameter 162 of the channel 114, may refer to a rate of the estimated flow of the fluid 102 into 104 the receptacle 110, when the flow control device 116 is in the OFF state. In other words, the processor 120 may determine the first flow estimate parameter 162 of the channel 114, when the flow control device 116 is not in operation and fluid 102 is retained in, and not being conveyed from 104 the receptacle 110. In system 100, the processor 120 may determine that the flow control device 116 is in the OFF state, based on the historical power parameter 142, and/or the historical operating parameter 144.

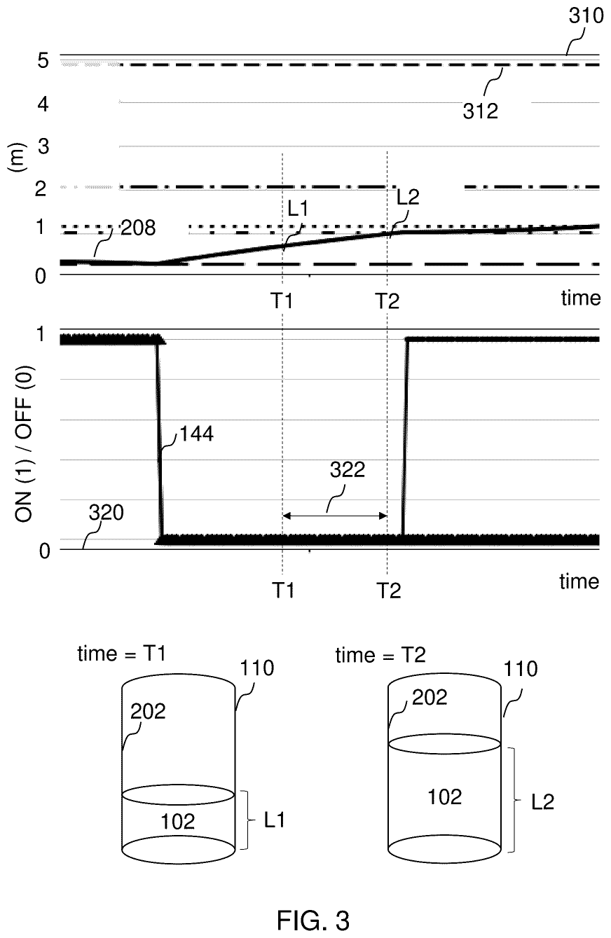

FIG. 3 shows an exemplary schematic illustration for determining a change in the historical filling parameter 160, when the flow control device 116 is in the OFF state. In FIG. 3, graph 310 may refer to a level 208 of the fluid 102 in the receptacle 110 over a sampled time period; and graph 320 may refer to the historical operating parameter 144 of the historical operating status of the flow control device 116, over the same sampled time period.

In graph 310, the y-axis may refer to the level 208 of the fluid 102, measured in meters (m), wherein the maximum fluid level 312 of the receptacle 110 may be 5 m. In graph 320, the y-axis may refer to the operating status of the flow control device 116 and may have a value indicated as “0” when it is in the OFF state, and may have a value indicated as “1” when it is in the ON state. In both graphs 310 and 320, the x-axis may refer to the duration of the sampled time period.

Referring to FIGS. 1 to 3, the processor 120 may determine the first flow estimate parameter 162 of the channel 114, based on a change in the historical filling parameter 160, when the flow control device 116 is in the OFF state. In various embodiments, the first flow estimate parameter 162 of the channel 114 may be an average of the change in the historical filling parameter 160, when the flow control device 116 is in the OFF state.

As shown in FIG. 3, the change in the historical filling parameter 160 may comprise a difference between a first historical filling state comprising a first level L1 of the fluid 102 in the receptacle 110 at a first sampled time T1, and a second historical filling state comprising a second level L2 of the fluid 102 in the receptacle 110 at the second sampled time T2, wherein the first sampled time T1 and the second sampled time T2 refer to sampled time points within the sampled time period. The change in the historical filling parameter 160 may also be expressed as Equation 1 below,

$$Δ historical filling parameter = L {1}_{T 1} - L {2}_{T 2} ; \qquad Equation ( 1 )$$

where L171 refers to the first level L1 of the fluid 102 in the receptacle 110 at a first sampled time T1; and L272 refers to the second level L2 of the fluid 102 in the receptacle 110 at a second sampled time T2.

In various embodiments, an interval 322 between the first sampled time T1 and the second sampled time T2, may be predetermined. In some embodiments, an interval 322 between the first sampled time T1 and the second sampled time T2, may be arbitrarily sampled or determined.

Referring back to FIG. 1, the processor 120 is further configured to determine, the first flow parameter 164 of the channel 114, based on the first flow estimate parameter 162, and the historical filling parameter 160. In various embodiments, the first flow parameter 164 of the channel 114 may comprise, a rate of the flow of the fluid 102 into 104 the receptacle 110. In various embodiments, the processor 120 may obtain, from the historical data 140, the historical filling parameter 160 at various sampled times when the flow control device 116 is in the ON state, and obtain the historical filling parameter 160 at said various sampled times.

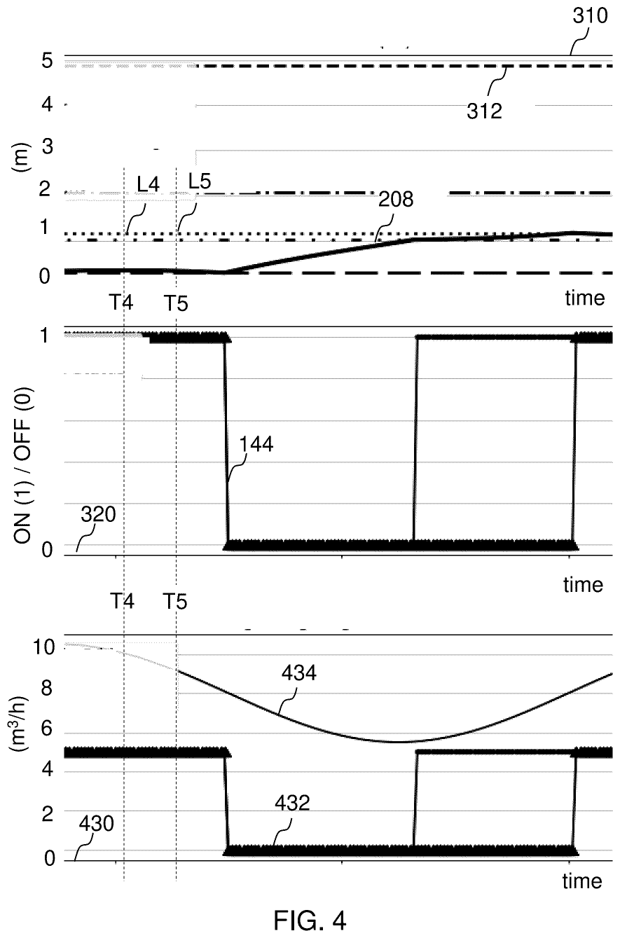

FIG. 4 shows an exemplary schematic illustration for obtaining the historical filling parameter 160 at various sampled times when the flow control device 116 is in the ON state. FIG. 4 may be based on FIG. 3, and the descriptions for graphs 310 and 320 may not be repeated. FIG. 4 may refer to the system 100 in the calibration configuration, and may therefore show the historical actual inflow 434 of the fluid 102 into 106 the receptacle 110 via the channel 114, and the historical outflow 432 of the fluid 102 from 104 the receptacle 110 via the flow control device 116, over the same sampled time period. In graph 430 of FIG. 4, the x-axis may refer to the duration of the sampled time period, and the y-axis may refer to the flow rate measured in cubic meters per hour (m³/h).

In various embodiments, the historical data 140 may further include the historical actual inflow 434 of the channel 114, indicative of the historical flow of the fluid 102 into 106 the receptacle 110. The historical actual inflow 434 may refer to a rate of a flow of the fluid 102, or the total volumetric flow of the fluid 102, into 106 the receptacle 110.

In various embodiments, the processor 120 may estimate, a historical flow control device parameter, based on the historical actual inflow 434 of the channel 114, and the corresponding historical filling parameter 160 indicative of the level 208 of the fluid 102 in the receptacle 110, when the flow control device 116 is in the ON state.

In some embodiments, to determine the historical flow control device parameter when said flow control device 116 is in the ON state, the processor 120 may obtain, a difference between, a fourth historical filling state comprising a fourth level L4 of the fluid 102 in the receptacle 110 at the fourth sampled time T4; and the fourth historical filling state comprising a fifth level L5 of the fluid 102 in the receptacle 110 at the fifth sampled time T5. The processor 120 may further obtain, a historical actual inflow 434 of the channel 114, and determine the historical flow control device parameter of the flow control device 116 based on said fourth historical filling state, fifth historical filling state and the historical actual inflow 434 of the channel 114. In some other embodiments, the corresponding historical filling parameter 160 indicative of the level 208 of the fluid 102 in the receptacle 110 when the flow control device 116 is in the ON state, may refer to a historical filling state comprising a level 208 of the fluid 102 in the receptacle 110 at a sampled time, e.g. fourth level L4 at sampled time T4.

Accordingly, the processor 120 may determine, the first flow parameter 164 of the channel 114, based on the first flow estimate parameter 162 of the channel 114, when the flow control device 116 is in the OFF state, and the historical filling parameter 160. The system 100 described above may be with reference to the system 100 in the calibration configuration, which may be used for determining a second flow parameter 168 of the flow control device 116, when the flow control device 116 is in an ON state, in real-time or near real-time.

Referring to FIG. 1, the processor 120 may be in data communication with the one or more sensors arranged on the receptacle 110 and/or the flow control device 116, to obtain a present data 150 indicative of real-time or near real-time data relating to the flow control device 116, and the filling state of the receptacle 110.

The present data 150 may comprise a present operating parameter 154 indicative of a present operating status of the flow control device 116. In various embodiments, the present operating parameter 154 may refer to a present status of the flow control device 116 when it is in the ON state, i.e. in operation, and conveying the fluid 102 from 104 the receptacle 110; or in the OFF state, i.e. not in operation, and may not convey the fluid 102 from 104 the receptacle 110. The OFF state may refer to an idle OFF state or a ready OFF state, as explained above.

The present data 150 may further comprise a present power parameter 152 indicative of a present power utilized by the flow control device 116. The present power parameter 152 may comprise to a present power, voltage and/or current utilized by the flow control device 116. In various embodiments, the processor 120 may obtain, the present operating parameter 154 based on the present power parameter 152. For example, the processor 120 may determine, the flow control device 116 as being in the ON state, when the present power parameter 152 has a value greater than 0, indicating that the flow control device 116 is in operation; or may determine, the flow control device 116 as being in the OFF state, when the historical power parameter 142 has a value equal to or less than 0, indicating that the flow control device 116 is not in operation.

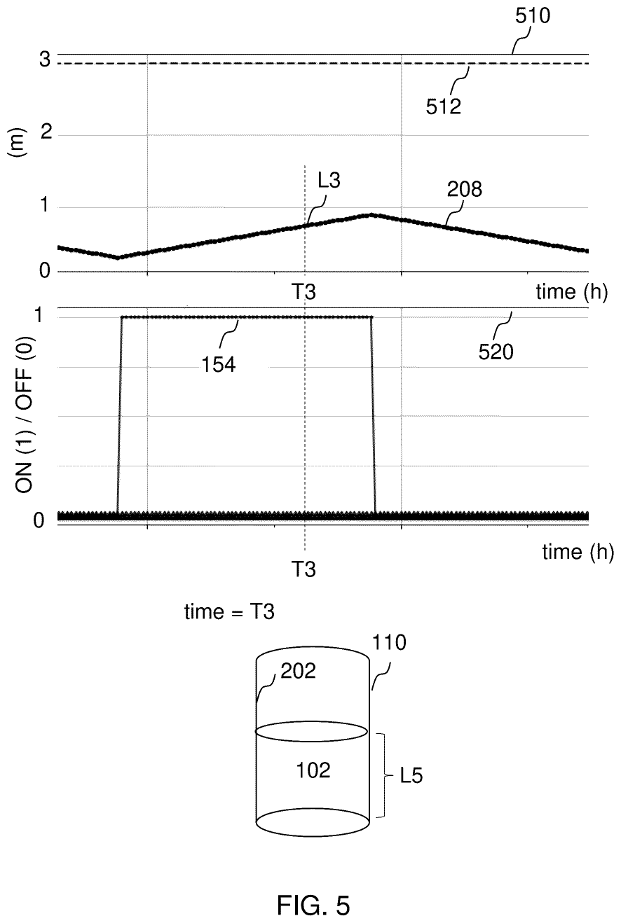

FIG. 5 shows an exemplary schematic illustration of obtaining, a present filling parameter 166 indicative of the present filling state of the internal volume 202 of the receptacle 110. In FIG. 5, graph 510 may refer to a level 208 of the fluid 102 in the receptacle 110 over a present sampled time period; and graph 520 may refer to the present operating parameter 154 of the present operating status of the flow control device 116, over the same present sampled time period.

In graph 510, the y-axis may refer to the level 208 of the fluid 102, measured in meters (m), wherein the maximum fluid level 512 of the receptacle 110 may be 3 m. In graph 520, the flow control device 116 may have a value indicated as “O” when it is in the OFF state, and may have a value indicated as “1” when it is in the ON state. In both graphs 510 and 520, the x-axis may refer to the duration of the sampled time period.

The present data 150 may further comprise a present filling parameter 166 indicative of a present filling state of the internal volume 202 of the receptacle 110. In various embodiments, the present filling parameter 166 may refer to a level 208 of the fluid 102 in the receptacle 110 at a present sampled time. The level 208 of the fluid 102 may be measured using one or more sensors, e.g. fluid level sensors, configured to measure the level 208 of the fluid 102, at the present sampled time. For example, the fluid level sensor may be a pressure sensor placed at a certain depth in the receptacle 110, and configured to output the level 208 of the fluid 102 based on the measured pressure of the fluid 102 contained in the receptacle 110.

As shown in FIG. 5, the present filling parameter 166 indicative of the present filling state of the internal volume 202 of the receptacle 110 may refer to a third level L3 of the fluid 102 in the receptacle 110 at the third sampled time T3. In various embodiments, the present filling parameter 166 may be obtained when the flow control device 116 is in the ON state, and fluid 102 may be conveyed from 104 the receptacle 110.

Referring to FIGS. 1 to 5, the processor 120 may be further configured to determine, a second flow parameter 168 of the flow control device 116, when said flow control device 116 is in the ON state, e.g. flow of the fluid 102 conveyed from 104 the receptacle 110 by the flow control device 116, based on the first flow parameter 164 of the channel 114, e.g. flow of the fluid 102 into 106 the receptacle 110, the present operating parameter 154, and the present filling parameter 166. In various embodiments, the second flow parameter 168 may refer to a rate of the flow of the fluid 102 from 104 the receptacle 110, when the flow control device 116 is in operation, i.e. ON state.

The processor 120 may be further configured to determine an efficiency of the flow control device 116. As shown in FIG. 1, the processor 120 may determine, a present efficiency 170 of the flow control device 116, based on the present power parameter 152. In various embodiments, the processor 120 may obtain a present input power supplied to the flow control device 116, which may be measured by one or more sensors, e.g. power meters, arranged on the flow control device 116. The processor 120 may further determine, the present efficiency 170 as a ratio the present power parameter 152, and the input power.

In various embodiments, the processor 120 may further determine, a historical efficiency 172 of the flow control device 116 based on the historical power parameter 142. The processor 120 may further obtain, a historical input power supplied to the flow control device 116, which may be measured by one or more sensors, e.g. power meters, arranged on the flow control device 116. The processor 120 may determine, the historical efficiency 172 of the flow control device 116, as a ratio of the historical power parameter 142, and the historical input power.

As shown in FIG. 1, the processor 120 may further determine, a difference 174 between the historical efficiency 172 and present efficiency 170 of the flow control device 116. Said difference 174 may be representative of a degradation in the performance the flow control device 116 over time.

While system 100 as described with reference to FIGS. 1 to 5 shows the system 100 including one flow control device 116, embodiments of the disclosure are not limited thereto, and the system 100 may include two or more flow control device 116, each in fluid communication with the receptacle 110 and each have the same operating configuration, e.g. configured to convey the fluid 102 from 104 the receptacle 110 as shown in FIG. 1. In various embodiments, the two or more flow control devices 116 may be operating simultaneously, or may not be operating at simultaneously. In other words, each flow control device 116 of the two or more flow control devices 116 may operate independently of each other. In some embodiments, at least one of the two or more flow control device 116 may be in operation.

In various embodiments, the present data 150 may further comprise, the present power parameter 152 and the present operating parameter 154 for each of the two or more flow control devices 116, in addition to the present filling parameter 166. The processor 120 may determine, for each of the two or more flow control devices 116, the second flow parameter 168 of said flow control device 116, when a respective one of the two or more flow control device 116 is in the ON state. In other words, the present power parameter 152 and the present operating parameter 154 may be obtained for each individual flow control device 116, and the second flow parameter 168 determined for said each individual flow control device 116, among the two or more flow control devices 116.

As described above, the second flow parameter 168 of each flow control device 116 may be determined based on the first flow parameter 164 of the channel 114, e.g. flow of the fluid 102 into 106 the receptacle 110, the present operating parameter 154, e.g. to determine when each of the flow control devices 116 are in the ON state, and the present filling parameter 166.

While system 100 described with reference to FIGS. 1 to 5 may represent a configuration where the flow control device 116 is configured to convey the fluid 102 from 104 the receptacle 110, and accordingly, the first flow parameter 164 of the channel 114 and second flow parameter 168 of the flow control device 116, may be representative of the flow of the fluid 102 into 106, and from 104, respectively, the receptacle 110, embodiments of the disclosure are not limited thereto.

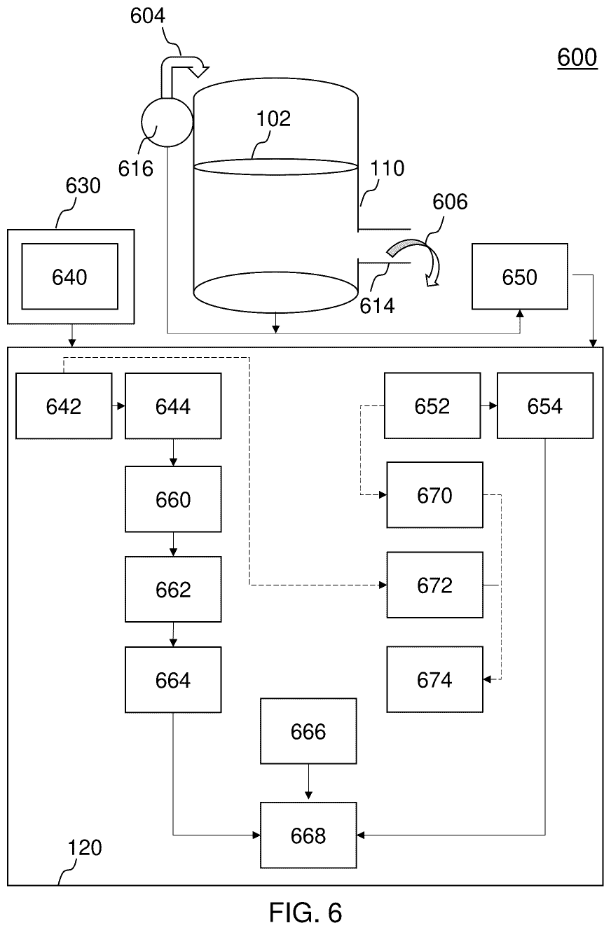

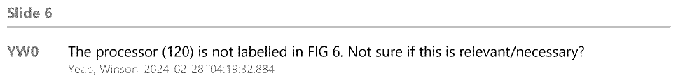

In this regard, FIG. 6 shows another exemplary schematic illustration of a system 600 for determining a first flow parameter 664 of a channel 614, and a second flow parameter 668 of a flow control device 616, the channel 614 and the flow control device 616 arranged in fluid communication with a receptacle 110, in accordance with various other embodiments of an aspect of the disclosure. System 600 may be based on system 100 described with reference to FIGS. 1 to 5 of the disclosure, and repeated descriptions will be omitted for brevity. The description below will thus focus on the differences between of system 600 and system 100.

Referring to FIG. 6, system 600 includes the channel 614 arranged to permit a flow of the fluid 102 from 606 the receptacle 110, and the flow control device 616 arranged to convey fluid 102 into 604 the receptacle 110. In various embodiments, the channel 614 may passively permit the flow of the fluid 102 from 606 the receptacle 110, e.g. via gravity; and the flow control device 616 may comprise an electrical pump configured to actively convey the fluid 102 into 604 the receptacle 110.

In various embodiments, the processor 120 obtains the historical data 640 from a storage device 630, e.g. a memory, the historical data 640 comprising a historical power parameter 642 indicative of the historical power utilized by the flow control device 616, a historical operating parameter 644 indicative of a historical operating status of the flow control device 616, and a historical filling parameter 660 indicative of a historical filling state of the internal volume 202 of the receptacle 110. In some embodiments, the processor 120 may obtain, the historical operating parameter 644 of the flow control device 616, based on the historical power parameter 642.

The processor 120 determines, the first flow estimate parameter 662 of the channel 614 indicative of an estimated flow of the fluid 102 from 606 the receptacle 110 via said channel 614, when the flow control device 616 is in an OFF state, based on the historical data 640. In various embodiments, the first flow estimate parameter 626 may be determined based on a change in the historical filling parameter 660, and the historical operating parameter 644 for determining when the flow control device 616 is in the OFF state. The processor 120 may be configured to determine the change in the historical filling parameter 660 in a similar manner as that described with reference to FIG. 3, and repeated descriptions will be omitted for brevity.

In various embodiments, the first flow estimate parameter 662 of the channel 614 may include a rate of the flow of the fluid 102 from 606, the receptacle 110, when the flow control device 616 is in the OFF state. Alternatively, the first flow estimate parameter 662 of the channel 614 may include a total volumetric flow of the fluid 102 from 606, the receptacle 110, when the flow control device 616 is in the OFF state.

The processor 120 further determines, the first flow parameter 664 of the channel 614 for permitting a flow of the fluid 102 from 606 the receptacle 110, based on the first flow estimate parameter 662 of the channel 614 when the flow control device 616 is in the OFF state, and the historical filling parameter 660. The processor 120 may be configured to determine the first flow parameter 664 of the channel 614, in a similar manner as that described with reference to FIG. 4, and repeated descriptions will be omitted for brevity. In various embodiments, the first flow parameter 664 of the channel 614 may include a rate of the flow of the fluid 102 from 606, or in some embodiments, a total volumetric flow of the fluid 102 from 606, the receptacle 110.

In various embodiments, the processor 120 may be further configured to obtain, a present data 650 from the flow control device 616 and the receptacle 110. The present data 650 may comprise, a present power parameter 652 indicative of a present power utilized by the flow control device 616. The present power parameter 652 may be measured by one or more sensors, e.g. power meters, and provided to the processor 120. The present data 650 may further include a present operating parameter 654 indicative of a present operating status of the flow control device 616. In some embodiments, the processor 120 may obtain, the present operating parameter 654 of the flow control device 616, based on the historical power parameter 642. The present data 650 may also include a present filling parameter 666 indicative of a present filling state of the internal volume 202 of the receptacle 110. For example, the present filling parameter 666 comprise a level 208 of the fluid 102 in the receptacle 110, at a present sampled time, and may be measured using one or more sensors, e.g. fluid level meters, configured to detect the fluid 102 level 208. Detailed descriptions for determining the present filling parameter 666 has been described with reference to FIG. 5 and repeated descriptions will be omitted for brevity.

The processor 120 may further determine, the second flow parameter 668 of the flow control device 616, when said flow control device 616 is in the ON state and conveying fluid 102 into 604 the receptacle 110, based on the first flow parameter 664 of the channel 614, the present operating parameter 654 (for determining when the flow control device 616 is in the ON state), and the present filling parameter 666.

Similar to system 100, the processor 120 of system 600 may be further configured to determine an efficiency of the flow control device 616, for conveying fluid 102 into 604 the receptacle 110. In various embodiments, the processor 120 may determine, the present efficiency 670 of the flow control device 616 based on the present power parameter 652, in a similar manner as described with reference to system 100.

In various embodiments, the processor 120 of system 600 may further determine, a historical efficiency 672 of the flow control device 616, based on the historical power parameter 642 and determine, a difference 674 between the historical efficiency 672 and the present efficiency 670, of the flow control device 616, in a similar manner as described with reference to system 100.

In various embodiments, system 600 may include two or more flow control devices 616, each of which in fluid communication with the receptacle 110, and configured to convey the fluid 102 into 604 the receptacle 110. The flow control devices 616 may each have a same operating configuration, but may or may not necessarily be operating at the same time, i.e. operating independently of each other.

In various embodiments, the present data 650 may further comprise the present operating parameter 654 indicative of the present operating status of each of the two or more flow control devices 616, i.e. each individual flow control device 616. The processor 120 may be further configured to determine, the second flow parameter 668 for each of the two or more flow control devices 616, when a respective one of the two or more flow control devices 616 is in the ON state, based on the first flow parameter 664 of the channel 614, the present operating parameter 654 for the respective one of the two or more flow control devices 616, and the present filling parameter 666.

System 600 as shown in FIG. 6 may therefore represent a configuration where the flow control device 616 is configured to convey the fluid 102 into 604 the receptacle 110, and accordingly, the first flow parameter 664 of the channel 614 and second flow parameter 668 of the flow control device 616, may be representative of the flow of the fluid 102 into 604 and from 606, respectively, the receptacle 110.

According to another aspect of the disclosure, there is provided a wastewater treatment plant comprising the system 100, 600 described with reference to FIGS. 1 to 6.

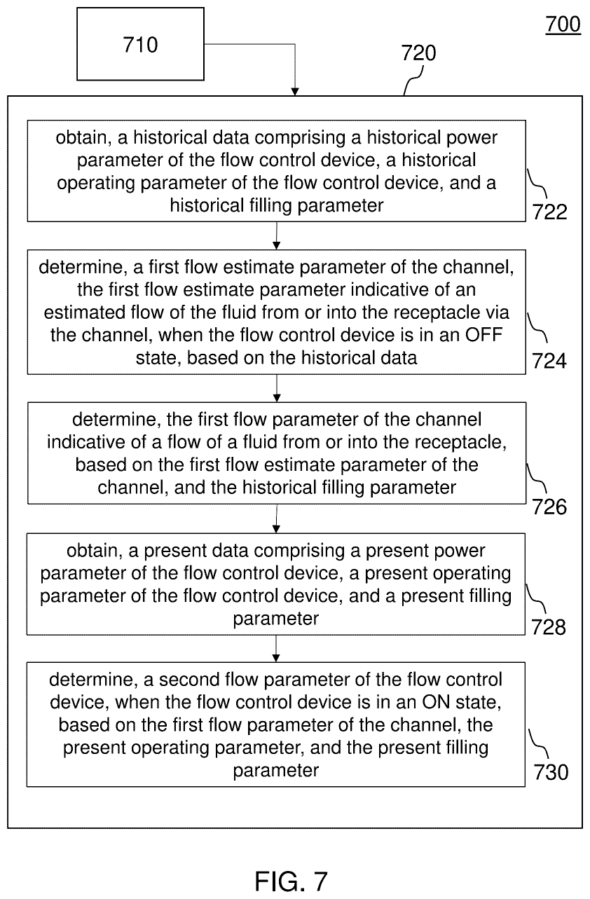

FIG. 7 shows an exemplary schematic illustration of a control device 700 comprising a processor 720 for determining a first flow parameter of a channel, and a second flow parameter of a flow control device, for a system, in accordance with another aspect of the disclosure. The control device 700 may be configured for system 100, 600 described with reference to FIGS. 1 to 6 of the present disclosure, and repeated descriptions are omitted for brevity.

In various embodiments, the system may include the channel arranged in fluid communication with a receptacle and configured to permit a flow of a fluid into or from the receptacle; and a flow control device arranged in fluid communication with the receptacle, and configured to convey the fluid from or into the receptacle.

Referring to FIG. 7, the control device 700 includes a processor 720 in data communication with a memory 710 having instructions stored therein, the instructions, when executed by the processor, causes the processor 720 to: obtain, a historical data comprising at least one of, a historical power parameter indicative of a historical power utilized by the flow control device; a historical operating parameter indicative of a historical operating status of the flow control device; and a historical filling parameter indicative of a historical filling state of an internal volume of the receptacle (step 722); determine, a first flow estimate parameter of the channel, the first flow estimate parameter indicative of an estimated flow of the fluid from or into the receptacle via the channel, when the flow control device is in an OFF state, based on the historical data (step 724); and determine, the first flow parameter of the channel indicative of a flow of a fluid from or into the receptacle, based on the first flow estimate parameter of the channel, and the historical filling parameter (step 726).

In various embodiments, the processor 120 may further obtain, a present data comprising at least one of, a present power parameter indicative of a present power utilized by the flow control device, a present operating parameter indicative of a present operating status of the flow control device, and a present filling parameter indicative of a present filling state of the internal volume of the receptacle (step 728);

and determine, in real-time or near real-time, the second flow parameter of the flow control device, when the flow control device is in an ON state, based on the first flow parameter of the channel, the present operating parameter, and the present filling parameter (step 730).

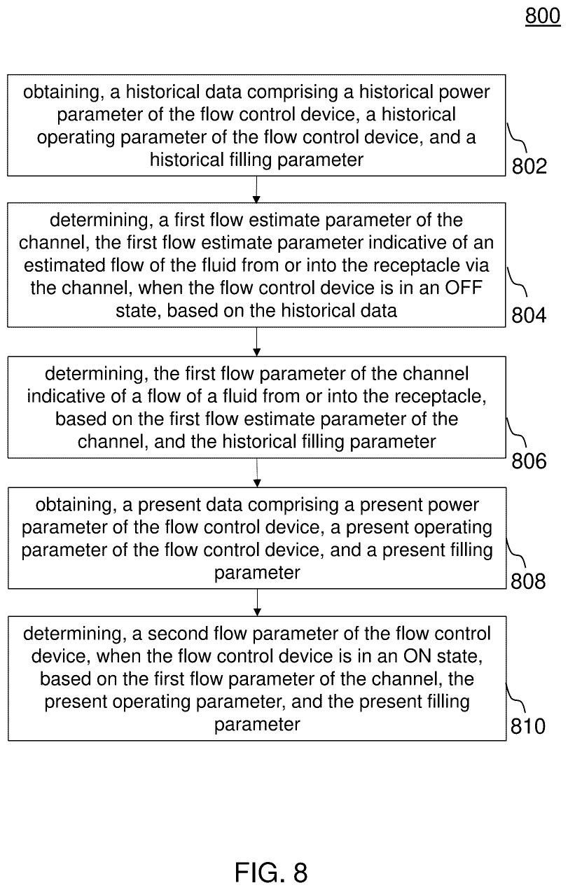

FIG. 8 shows an exemplary flowchart of a method 800 for determining, a first flow parameter of a channel, and a second flow parameter of a flow control device, for a system, in accordance with another aspect of the disclosure. The method 800 may be configured for operating the system 100, 600 described with reference to FIGS. 1 and 6 of the disclosure, and repeated descriptions are omitted for brevity.

In various embodiments, the system may include the channel arranged in fluid communication with a receptacle and configured to permit a flow of a fluid into or from the receptacle; and a flow control device arranged in fluid communication with the receptacle, and configured to convey the fluid from or into the receptacle.

Method 800 comprises providing a processor for: obtaining, a historical data comprising at least one of, a historical power parameter indicative of a historical power utilized by the flow control device; a historical operating parameter indicative of a historical operating status of the flow control device; and a historical filling parameter indicative of a historical filling state of an internal volume of the receptacle (step 802); determining, a first flow estimate parameter of the channel, the first flow estimate parameter indicative of an estimated flow of the fluid from or into the receptacle via the channel, when the flow control device is in an OFF state, based on the historical data (step 804); and determining, the first flow parameter of the channel indicative of a flow of fluid from or into the receptacle, based on the first flow estimate parameter of the channel, and the historical filling parameter (step 806).

Method 800 may further include providing the processor for: obtaining, a present data comprising at least one of a present power parameter indicative of the present power utilized by the flow control device, a present operating parameter indicative of a present operating status of the flow control device, and a present filling parameter indicative of a present filling state of the internal volume of the receptacle (step 808); and determining, in real-time or near real-time, a second flow parameter of the flow control device, when the flow control device is in an ON state, based on the first flow parameter of the channel, the present operating parameter, and the present filling parameter (step 810).

In various embodiments of method 800, determining, the first flow estimate parameter of the channel based on the historical data, comprises determining, a change in the historical filling parameter; and determining, the first flow estimate parameter of the channel, based on the change in the historical filling parameter and the historical operating parameter. In some embodiments, the change in the historical filling parameter indicative of the historical filling state of the internal volume of the receptacle, when the flow control device is in the OFF state comprises, a difference between a first historical filling state comprising a first level of the fluid in the receptacle at a first sampled time; and a second historical filling state comprising a second level of the fluid in the receptacle at a second sampled time.

In various embodiments of method 800, the processor obtains the historical operating parameter based on the historical power parameter.

In various embodiments of method 800, the flow control device comprises an electrical pump.

In various embodiments of method 800, the processor further: determines, a present efficiency of the flow control device, based on the present power parameter.

In various embodiments of method 800, the processor further: determines, a historical efficiency of the flow control device, based on the historical power parameter; and determines, a difference between the historical efficiency and the present efficiency, of the flow control device.

In various embodiments of method 800, the present filling parameter indicative of the present filling state of the internal volume of the receptacle comprises, a third level of the fluid in the receptacle at a third sampled time.

In various embodiments of method 800, the flow control device comprises two or more second flow control devices, wherein each of the two or more second flow control devices are in fluid communication with the receptacle, and configured to convey the fluid from the receptacle, or to convey the fluid into the receptacle, wherein the two or more second flow control devices each have a same operating configuration, and wherein the present data further comprises, the present operating parameter indicative of the present operating status of each of the two or more second flow control devices; wherein the processor is further: determines, the second flow parameter for each of the two or more second flow control devices, when a respective one of the two or more second flow control devices are in the ON state, based on the first flow parameter of the channel, the present operating parameter for the respective one of the two or more second flow control devices, and the present filling parameter.

In various embodiments of method 800, the internal volume of the receptacle comprises, a section profile along a vertical axis of the receptacle.

According to another aspect of the disclosure, there is provided a computer readable medium comprising instructions, which when executed by the processor, causes the processor to perform the method 800 described with reference to FIG. 8.

Embodiments of the disclosure thus provides an improved system 100, 600 which reduces and/or removes the need for the use of conventional flow meters for measuring and monitoring the flow of the fluid 102 from 606 or into 106 the receptacle 110 via channels 114, 614, and/or measuring and monitoring the conveying of a fluid 102 from 104 or into 604 the receptacle 110 via flow control devices 116, 616, thereby reducing installation, operating and/or maintenance costs related to such conventional flow meters. In addition, the improved system 100, 600 is able to determine the first flow parameter 164, 664 and the second flow parameter 168, 668 with improved accuracy, when compared with conventional flow meters.

The system 100, 600 and method 800 herein disclosed are further illustrated in the following examples, which are provided by way of illustration and are not intended to be limiting the scope of the present disclosure.

The example illustrated herein may be based on system 600, where the channel 614 is configured to permit the flow of the fluid 102 from 606 the receptacle 110, and the flow control device 616, e.g. first flow control device may be configured to convey fluid 102 into 604 the receptacle 110. While not illustrated in FIG. 6, the system 600 may further include another flow control device, e.g. second flow control device, such as two flow control devices operating in the same configuration, configured to convey fluid 102 into 604 the receptacle 110.

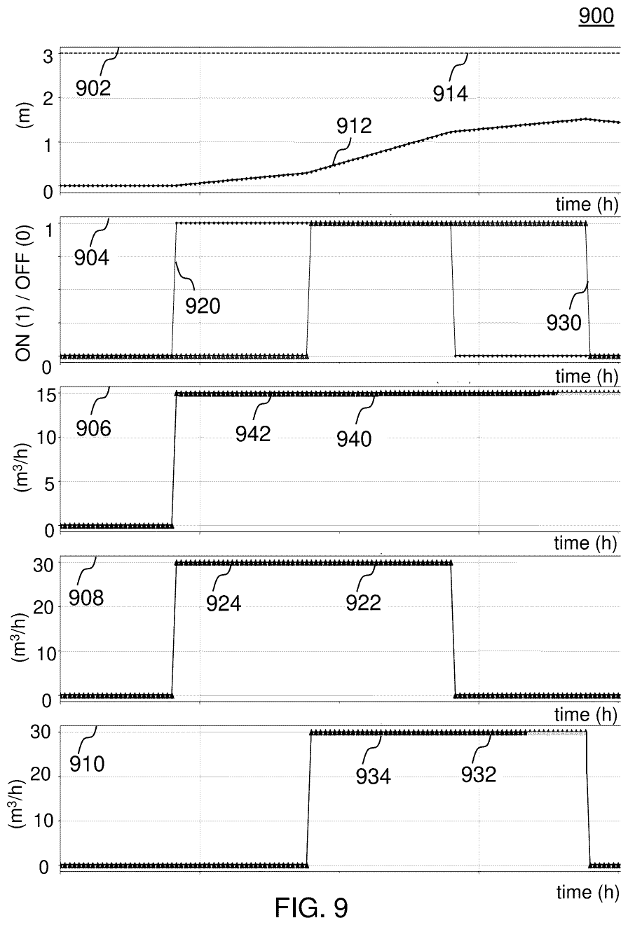

FIG. 9 shows a series of graphs 900 demonstrating the performance of the system 600 for determining the first flow parameter 664 of the channel 614, and the second flow parameter 668 of the flow control device 616, e.g. first flow control device, and the another flow control device, e.g. second flow control device. In the series of graph 900, the x-axis may represent the duration of the time period.

Graph 902 shows a filling state 912 of an internal volume 202 of the receptacle 110, over the duration of the time period (x-axis). The y-axis may refer to the level 208 of the fluid 102, measured in meters (m). In graph 902, the maximum 914 level of the receptacle 110 may be 3 m.

Graph 904 shows an operating status 920 of the flow control device 616, e.g. first flow control device, and an operating status 930 of the another flow control device, e.g. second flow control device, over the same duration of the time period (x-axis). The y-axis may refer to the operating status of the flow control device 116 and may have a value indicated as “0” when it is in the OFF state, and may have a value indicated as “1” when it is in the ON state.

Graph 906 shows the comparison between an actual outflow rate 940 of the fluid 102 via the channel 614, and the determined outflow rate 942 of the fluid 102, e.g. first flow parameter 664 indicative of the flow from the fluid 102 via the channel 614, over the same duration of the time period (x-axis). The y-axis may refer to the flow rate of the fluid 102, measured in cubic meters per hour (m³/h).

Graph 908 shows the comparison between an actual inflow rate 922 of the fluid 102 via the flow control device 616, e.g. first flow control device, and the determined inflow rate 924 of the fluid 102, e.g. second flow parameter 668 indicative of the flow from the fluid 102 via the flow control device 616, e.g. first flow control device, over the same duration of the time period (x-axis). Graph 910 shows the comparison between an actual inflow rate 932 of the fluid 102 via the another flow control device, e.g. second flow control device, and the determined inflow rate 934 of the fluid 102, e.g. second flow parameter 668 indicative of the flow from the fluid 102 via the another flow control device, e.g. second flow control device, over the same duration of the time period (x-axis). In graphs 908, 910, the y-axis may refer to the flow rate for the respective flow control devices 616, e.g. first flow control device and the another flow control device measured in cubic meters per hour (m³/h).

As shown in the series of graphs 900 in FIG. 9, the results in graphs 906, 908 and 910 show that the improved system 600 may be able to determine the first flow parameter 664 indicative of the flow of the fluid 102 from 606 the receptacle 110 via the channel 614; and the second flow parameter 668 for each of the flow control devices 616, e.g. first flow control device and the another flow control device, the second flow parameter 668 indicative of the conveyed flow of the fluid 102 into 604 the receptacle 110, with improved accuracy.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A system for determining a first flow parameter of a channel, the channel arranged in fluid communication with a receptacle, the first flow parameter indicative of a flow of a fluid from or into the receptacle via the channel, the system comprising
a flow control device, in fluid communication with the receptacle, the flow control device configured to convey the fluid from the receptacle, or configured to convey the fluid into the receptacle;
a processor configured to
obtain, a historical data comprising at least one of,
a historical operating parameter indicative of a historical operating status of the flow control device;
a historical filling parameter indicative of a historical filling state of an internal volume of the receptacle;
determine, a first flow estimate parameter of the channel, the first flow estimate parameter indicative of an estimated flow of the fluid from or into the receptacle via the channel, when the flow control device is in an OFF state, based on the historical data; and
determine, the first flow parameter of the channel, based on the first flow estimate parameter of the channel, and the historical filling parameter.

2. The system of claim 1, wherein determining, the first flow estimate parameter of the channel, based on the historical data, comprises
determining, a change in the historical filling parameter; and
determining, the first flow estimate parameter of the channel, based on the change in the historical filling parameter and the historical operating parameter.

3. The system of claim 2, wherein the change in the historical filling parameter indicative of the historical filling state of the internal volume of the receptacle, when the flow control device is in the OFF state, comprises, a difference between
a first historical filling state comprising a first level of the fluid in the receptacle at a first sampled time; and
a second historical filling state comprising a second level of the fluid in the receptacle at a second sampled time.

4. The system of claim 1, wherein the flow control device comprises an electrical pump.

5. The system of claim 4, wherein the processor is further configured to
obtain, a present data comprising a present power parameter indicative of a present power utilized by the flow control device and
determine, a present efficiency of the flow control device, based on the present power parameter.

6. The system of claim 5, wherein the historical data further comprises a historical power parameter indicative of a historical power utilized by the flow control device,
wherein the processor is further configured to
determine, a historical efficiency of the flow control device, based on the historical power parameter, and
determine, a difference between the historical efficiency and the present efficiency, of the flow control device.

7. The system of claim 6, wherein the processor is configured to obtain, the historical operating parameter based on the historical power parameter.

8. The system of claim 5, wherein the present data further comprises at least one of,
a present operating parameter indicative of a present operating status of the flow control device;
a present filling parameter indicative of a present filling state of the internal volume of the receptacle;
wherein the processor is further configured to determine, a second flow parameter of the flow control device, when the flow control device is in an ON state, based on the first flow parameter of the channel, the present operating parameter, and/or the present filling parameter.

9. The system of claim 8, wherein the present filling parameter indicative of the present filling state of the internal volume of the receptacle comprises, a third level of the fluid in the receptacle at a third sampled time.

10. The system of claim 8, wherein the flow control device comprises two or more second flow control devices,
wherein each of the two or more second flow control devices are in fluid communication with the receptacle, and configured to convey the fluid from the receptacle, or to convey the fluid into the receptacle,
wherein the two or more second flow control devices each have a same operating configuration, and
wherein the present data further comprises, the present operating parameter indicative of the present operating status of each of the two or more second flow control devices;
wherein the processor is further configured to determine, the second flow parameter for each of the two or more second flow control devices, when a respective one of the two or more second flow control devices are in the ON state, based on the first flow parameter of the channel, the present operating parameter for the respective one of the two or more second flow control devices, and the present filling parameter.

11. The system of claim 1, wherein the internal volume of the receptacle comprises, a section profile along a vertical axis of the receptacle.

12. The system of claim 1, wherein the first flow parameter of the channel comprises, a rate of the flow of the fluid from or into the receptacle, and
wherein the first flow estimate parameter of the channel comprises, a rate of the estimated flow of the fluid from or into the receptacle, when the flow control device is in the OFF state.

13. The system of claim 1, wherein when the flow control device is configured to convey the fluid from the receptacle, the first flow parameter of the channel comprises the flow of the fluid into the receptacle.

14. The system of claim 1, wherein when the flow control device is configured to convey the fluid into the receptacle, the first flow parameter of the channel comprises the flow of the fluid from the receptacle.

15. The system of claim 1, wherein the fluid comprises water, or wastewater.

16. A wastewater treatment plant comprising the system of claim 1.

17. A control device comprising a processor for determining a first flow parameter of a channel for a system, the channel arranged in fluid communication with a receptacle, the first flow parameter indicative of a flow of a fluid from or into the receptacle; the system comprising
a flow control device in fluid communication with the receptacle, the flow control device configured to convey the fluid from the receptacle, or configured to convey the fluid into the receptacle;
the processor being in data communication with a memory having instructions stored therein, the instructions, when executed by the processor, causes the processor to
obtain, a historical data comprising at least one of,
a historical operating parameter indicative of a historical operating status of the flow control device;
a historical filling parameter indicative of a historical filling state of an internal volume of the receptacle;
determine, a first flow estimate parameter of the channel, the first flow estimate parameter indicative of an estimated flow of the fluid from or into the receptacle via the channel, when the flow control device is in an OFF state, based on the historical data; and
determine, the first flow parameter of the channel, based on the first flow estimate parameter of the channel, and the historical filling parameter.

18. A method for determining a first flow parameter of a channel for a system, the channel arranged in fluid communication with a receptacle, the first flow parameter indicative of a flow of a fluid from or into the receptacle;
the system comprising a flow control device in fluid communication with the receptacle, the flow control device configured to convey the fluid from the receptacle, or configured to convey the fluid into the receptacle;
the method comprising providing a processor for
obtaining, a historical data comprising at least one of,
a historical operating parameter indicative of a historical operating status of the flow control device;
a historical filling parameter indicative of a historical filling state of an internal volume of the receptacle;
determining, a first flow estimate parameter of the channel, the first flow estimate parameter indicative of an estimated flow of the fluid from or into the receptacle via the channel, when the flow control device is in an OFF state, based on the historical data; and
determining, the first flow parameter of the channel, based on the first flow estimate parameter of the channel, and the historical filling parameter.

19. The method of claim 18, wherein determining, the first flow estimate parameter of the channel based on the historical data, comprises
determining, a change in the historical filling parameter; and
determining, the first flow estimate parameter of the channel, based on the change in the historical filling parameter and the historical operating parameter.

20. The method of claim 19, wherein the change in the historical filling parameter indicative of the historical filling state of the internal volume of the receptacle, when the flow control device is in the OFF state comprises, a difference between
a first historical filling state comprising a first level of the fluid in the receptacle at a first sampled time; and
a second historical filling state comprising a second level of the fluid in the receptacle at a second sampled time.
